(19) United States
(12) Patent Application Publication
(10) Pub. No.: US 2005/0032945 A1
(43) Pub. Date: Feb. 10, 2005

(54) Vulcanizable rubber having increased scorch time

(76) Inventor: Philippe G. Moniotte, Heron (BE)

Correspondence Address: LOUIS A. MORRIS;AKZO NOBEL INC., 7 LIVINGSTONE AVENUE, DOBBS FERRY, NY, 10522-3408, US

(21) Appl. No.: 10/760,328

(22) Filed: Jan. 20, 2004

Related U.S. Application Data
(60) Provisional application No. 60/493,973, filed on Aug. 8, 2003.

(51) Int. Cl. C08L 1/00

(52) U.S. Cl. 524/157

(57) ABSTRACT

An improved product form for an additive for rubber vulcanizates which allows increased scorch safety time when using said additive. The additive comprises particles of Bunte salt containing two or more groups of the formula R-S—SO₃M, or a hydrate thereof, linked by an organic bridging group, where R represents an alkyl group, an alkenyl group, a cycloaliphatic group, an aromatic group, a heterocyclic group, or a radical which is a combination of two or more of such groups, and M represents a monovalent metal or the equivalent of a multivalent metal. In particular, the invention comprises a method for increasing the scorch safety time of a rubber vulcanizate when using such Bunte salt having a mean particle size of less than 15.0 micrometers.

### CROSS REFERENCE TO RELATED APPLICATION

This application claims priority from Provisional Patent Application 60/493,973, filed Aug. 8, 2003, all the contents of which are incorporated herein by reference thereto.

### BACKGROUND OF THE INVENTION

1. Field of the Invention

This invention relates to the use of additives in vulcanizable rubber compositions.

2. Prior Art

The use of Bunte salts containing two or more groups of the formula —S—SO₃-M linked by an organic bridging group are used in sulfur vulcanizates as network stabilizers and rubber to metal bonding promoters (U.S. Pat. Nos. 4,704,334: 4,417,012; EU0070143; and EU0109955). These patents mention that these high melting stabilizers should be ground to a fine powder (70 micrometer size or less) to ensure adequate dispersion in the rubber matrix.

When commercially processing rubber, the initial onset of vulcanization needs to be controlled in order to enable a processing safety time as measured by T5 scorch (ASTM D 1646). The network stabilizers of the above references do affect this vulcanization process by causing a reduction in this scorch safety time. The objective of the present invention is to increase the scorch safety time when using the above Bunte salts.

### SUMMARY OF THE INVENTION

In one embodiment, the invention comprises an improved product form for an additive for rubber vulcanizates to allow increased scorch safetytime when using the additive. The additive comprises particles of a Bunte salt containing two or more groups of the formula R-S—SO₃M, or a hydrate thereof, linked by an organic bridging group, where R represents an alkyl group, an alkenyl group, a cycloaliphatic group, an aromatic group, a heterocyclic group, or a radical which is a combination of two or more of such groups, and M represents a monovalent metal or the equivalent of a multivalent metal. The particles have a mean particle size of less than 15.0 micrometers.

In another specific embodiment, the invention comprises a method for increasing the scorch safety time of a rubber vulcanizate comprising the use of the additive hexamethylene-1,6-bis(thiosulfate),disodium salt, dihydrate.

Other embodiments of the invention comprise details as to additive and vulcanizate compositions and preparing the vulcanizate.

### BRIEF DESCRIPTION OF THE DRAWING

FIG. 1 comprises a graphical presentation of the results of the examples.

### DETAILED DESCRIPTION OF THE INVENTION

The preferred additive for use in the invention is hexamethylene-1,6-bis(thiosulfate), disodium salt, dihydrate. This additive is marketed by Flexsys America LP under the registered trademark Duralink®. Duralink® HTS additive has been used in sulfur based vulcanization systems to generate hybrid crosslinks which provide increased retention of physical and dynamic properties when exposed to anaerobic conditions at elevated temperatures such as those experienced during over-cure, when using high curing temperatures or during product service life.

Duralink® HTS additive may be represented by the following structural formula:

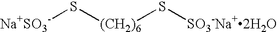

This application describes a way of controlling the scorch safety time of vulcanizates to desired values (or ranges) that will allow optimal curing of the vulcanizate with minimal impact on the T5 Scorch Safety while using Duralink® HTS additive. Surprisingly, it was discovered that the particle size of the additive of the invention significantly affects the scorch during the vulcanization process, and that smaller particles of additive were found to give longer scorch safety times when measured as T5 scorch.

In this application, the abbreviation “phr” means the number of parts by weight per 100 parts by weight of rubber. In the case of a rubber blend, it is based on 100 parts by weight of total rubber.

Either natural rubber (NR), styrene-butadiene rubber (SBR) or a blend of NR and SBR or NR and SBR with one or more other rubbers can be used in the invention process, it being understood that for purposes of this invention the term “rubber” means an elastomer containing a hydrocarbon unit which is a polymer with some unsaturated chemical bonds. Typically, SBR, a blend of SBR with natural rubber (NR), a blend of SBR with polybutadiene rubber or butadiene rubber (BR), or a blend of SBR with NR and BR is used. The type of rubber or mixture of rubbers will have some effect on the precise amounts of additive to be used.

Typically, the amount of additive employed in the rubber composition of the present invention will be at least about 0.5 phr. The preferred upper limit is about 5.0 phr, most preferably 3.0 phr.

A typical rubber composition in accordance with the present invention comprises a rubber, about 0.1 to about 5 phr of sulfur, about 0.5 to about 2 phr of a vulcanization accelerator, preferably a sulfenamide accelerator, about 0.1 to about 5 phr (preferably about 2 to about 3 phr) of the additive of the invention and a C₁₂-C₂₀ fatty acid such as stearic acid. Metal oxides such as zinc oxide typically are added to rubber compositions.

The rubber composition of the present invention typically also comprises a reinforcing filler in a conventional amount. Any carbon black or combination of carbon black with any silica may be used.

Conventional rubber additives may also be incorporated in the rubber composition according to the present invention. Examples include antireversion agents, processing oils, tackifiers, waxes, phenolic antioxidants, pigments, e.g. titanium dioxide, resins, plasticizers, and factices. These conventional rubber additives may be added in amounts known to the person skilled in the art of rubber compounding. The reader is also referred to the Examples described below.

Conventional rubber additives may also be included in the sulfur-vulcanizable rubber composition in accordance with the present invention. Examples include reinforcing agents such as carbon black, silica, clay, whiting and other mineral fillers, processing oils, tackifiers, waxes, phenolic antioxidants, phenylenediamine antidegradants, antiozonants, pigments, e.g. titanium dioxide, resins, plasticizers, factices, and vulcanization activators, such as stearic acid and zinc oxide. These conventional rubber additives may be added in amounts known to the person skilled in the art of rubber compounding. The reader is also referred to the examples that are described below.

For further details on these typical rubber additives and vulcanization inhibitors, see W. Hofmann, Rubber Technology Handbook, Hanser Publishers, Munich 1989.

Finally, in specific applications it may also be desirable to include steel-cord adhesion promoters such as cobalt salts and bis-thiosulfates in conventional, known quantities.

The composition of the present invention is useful in the manufacture of many articles, including pneumatic tires, e.g., for passenger cars and trucks, and industrial rubber goods, which comprise the rubber vulcanizate obtained by the method of the invention.

In conducting the experiments on which the following examples are based, the same batch of Duralink® HTS additive was milled using a Hosokawa Micron Powder systems Mikro-ACM® model 15 mill under different milling conditions to give milled material ranging from 5.0 to 28.3 micrometers. Surprisingly, there was found a direct correlation with the Duralink HTS mean particle size and the T5 scorch safety of the vulcanizate. In particular, the unmilled starting material had a particle size of 202 micrometers and gave a T5 scorch value of 37.9%. As the mean particle size of the additive was reduced by milling to 5.0 micron, the corresponding loss of scorch safety was reduced to a T5 value of 4.4%.

The invention is illustrated by the following examples.

General

Milling and Particle Size Analysis

Milling of the Duralink® HTS additive was carried out on an Air Classifier Mill (ACM). The desired particle size was obtained by varying the airflow, classifier speed and product feed rate parameters for each trial milling run.

The milled Duralink® HTS additive particle size was determined using a Horiba LA910 Laser scattering analyzer. The material was milled within a range of 5.0 to 28.3 micrometers for this trial before T5 scorch testing was carried out.

Scorch Determination

The T5 Scorch value for each trial milling run was determined using ASTM D-1646 standard Test methods for rubber viscosity, stress relaxation, and pre-vulcanization characteristics (Mooney Viscometer).

The rubber stock used had the following composition set forth in Table I:

TABLE I

| Ingredient | Parts by Weight |
|---|---|
| Natural Rubber | 100 |
| HAF Carbon Black | 50 |
| Zinc Oxide | 5 |
| Stearic Acid | 2 |
| Process Oil | 5 |
| Duralink ® HTS | 3 |
| 6-PPD¹ | 2 |
| Sulfur | 2 |
| TBBS² | 0.9 |

¹N-1,3-Dimethylbutyl-N′-phenyl-p-phenylenediamine
²N-t-Butyl-2-benzothiazolesulfenamide

Mixing of the components *(except sulfur, accelerator and Duralink® HTS additive) was done in a laboratory scale Banbury mixer having a capacity of 1.60 liter and operating at a filling factor of about 0.70 and a rotor speed of 60-77 r.p.m. according to the following schedule set forth in Table II:

TABLE II

| Time | |
|---|---|
| (mins.) | |
| 0 | Rubber placed in mixer and rotors started. |
| 2 | Half carbon black and zinc oxide added. |
| 4 | Remainder of carbon black, stearic acid and process oil |
| | added. |
| 6 | Sweep. |
| 8 | Dumped at temperature 150 ± 5° C. |

The batch was then transferred to a mill at 700 C for sheeting. Sulfur, accelerator and Duralink® HTS additive were added to portions of this masterbatch on a mill as required.

Flexsys Mooney MV 2000 instruments were used to determine the T5 time for each compounded Duralink® HTS additive controlled particle size milling trial. These Duralink® HTS additive T5 values are compared to a control T5 that was the above masterbatch that did not have Duralink® HTS additive added.

T5 Duralink® HTS additive % drop is the % change of the Duralink® HTS additive T5 value compared to a non-Duralink® HTS additive T5 value. Since the Duralink® HTS additive compounded stocks give faster T5 values than the control stock, a Duralink® HTS additive T5 scorch percent drop can be calculated using the following formula:
T5 scorch % drop=1-[(T5 Duralink® HTS additive Stock) ? (T5 control stock without Duralink® HTS additive)]×100.

### EXAMPLE #1

The production lot (unmilled) of Duralink® HTS additive had a 202 micrometer mean particle size. The T5 value for this material was 17.62 minutes. The control (no Duralink® HTS additive) for the same master batch had a T5 of 28.36 minutes. This gave a T5 scorch drop of 37.9% Example #2 The above material was milled to give a 5.0 micrometer mean particle size. The T5 value for this material was 26.88 minutes with a control T5 of 28.11 minutes. This gave a T5 scorch drop of 4.4%.

### EXAMPLE #3

Material was milled to give a 7.0 micrometer mean particle size. The T5 value for this material was 25.92 minutes with a control T5 of 28.37 minutes. This gave a T5 scorch drop of 8.6%.

### EXAMPLE #4

Material was milled to give a 10.2 micrometer mean particle size. The T5 value for this material was 24.25 minutes with a control T5 of 28.36 minutes. This gave a T5 scorch drop of 14.5%.

### EXAMPLE #5

Material was milled to give a 11.3 micrometer mean particle size. The T5 value for this material was 23.36 minutes with a control T5 of 28.11 minutes. This gave a T5 scorch drop of 16.9%.

### EXAMPLE #6

Material was milled to give a 13.5 micrometer mean particle size. The T5 value for this material was 23.11 minutes with a control T5 of 28.37 minutes. This gave a T5 scorch drop of 18.5%.

### EXAMPLE #7

Material was milled to give a 18.8 micrometer mean particle size. The T5 value for this material was 22.15 minutes with a control T5 of 28.36 minutes. This gave a T5 scorch drop of 21.9%.

### EXAMPLE #8

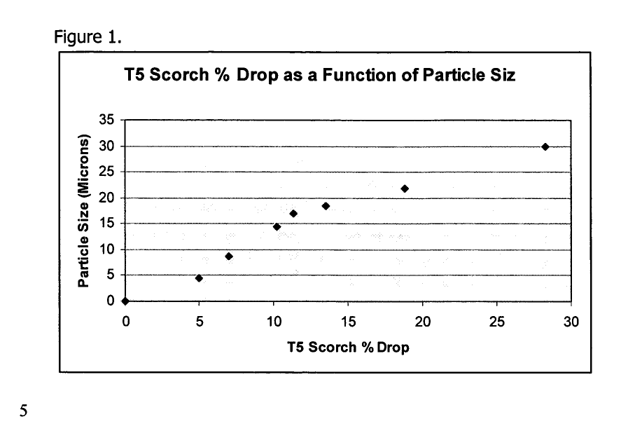

Material was milled to give a 28.3 micrometer mean particle size. The T5 value for this material was 19.71 minutes with a control T5 of 28.11 minutes. This gave a T5 scorch drop of 29.9%. The Data from the above examples is summarized below in Table III and FIG. 1.

TABLE III
T5 Scorch % Drop as a Function of Mean Particle Size

| Mean Particle Size (microns) | T5 Scorch % Drop |
|---|---|
| 202 (unmilled) | 37.9 |
| 28.3 | 29.9 |
| 18.8 | 21.9 |
| 13.5 | 18.5 |
| 11.3 | 16.9 |
| 10.2 | 14.5 |
| 7.0 | 8.6 |
| 5.0 | 4.4 |
| 0 (Control) | 0 |

1. An improved product form for an additive for rubber vulcanizates having increased scorch time when using said additive, comprising particles of a Bunte salt containing two or more groups of the formula R-S—SO₃M, or a hydrate thereof, linked by an organic bridging group, where R represents an alkyl group, an alkenyl group, a cycloaliphatic group, an aromatic group, a heterocyclic group, or a radical which is a combination of two or more of such groups, and M represents a monovalent metal or the equivalent of a multivalent metal, said particles having a mean particle size less than 15.0 micrometers.

2. The additive of claim 1 wherein said particles have a mean particle size of from about 1.0 to less than 15.0 micrometers.

3. The additive of claim 1 wherein R represents an alkyl group.

4. The additive of claim 3 wherein said additive comprises hexamethylene-1,6-bis(thiosulfate), disodium salt, dihydrate.

5. A method for increasing the scorch time of a rubber vulcanizate, when using an additive, comprising adding to said vulcanizate particles of an additive comprising a Bunte salt containing two or more groups of the formula R-S—SO₃M, or a hydrate thereof, linked by an organic bridging group, where R represents an alkyl group, an alkenyl group, a cycloaliphatic group, an aromatic group, a heterocyclic group, or a radical which is a combination of two or more of such groups, and M represents a monovalent metal or the equivalent of a multivalent metal, said particles having a mean particle size less than 15.0 micrometers.

6. The method of claim 1 wherein R represents an alkyl group.

7. The method of claim 5 wherein said additive comprises hexamethylene-1,6-bis(thiosulfate), disodium salt, dihydrate.
